(19) United States
(12) Patent Application Publication
(10) Pub. No.: US 2011/0012905 A1
(43) Pub. Date: Jan. 20, 2011

(54) INFORMATION PROCESSING APPARATUS, INFORMATION PROCESSING METHOD, AND COMPUTER-READABLE RECORDING MEDIUM HAVING PROGRAM RECORDED THEREON

(75) Inventor: Masakazu Kawahara, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 12/865,822

(22) PCT Filed: Mar. 23, 2009
(86) PCT No.: PCT/JP2009/055618

§ 371 Date: Aug. 2, 2010

(30) Foreign Application Priority Data
Apr. 17, 2008 (JP) 2008-108114

(51) Int. Cl. G06T 15/00

(52) U.S. Cl. 345/522

(57) ABSTRACT

An information processing apparatus includes: a display control unit for causing a display unit to display a reference circle arranged at a prescribed position and to display a moving graphic to be movable in accordance with a move command from an operation unit; a storage unit for storing a parameter in association with a position on a circumference of the reference circle; and a range deciding unit for calculating and outputting a parameter range corresponding to a portion of the circumference of the reference circle located within the moving graphic, based on a position of the moving graphic.

### TECHNICAL FIELD

The present invention relates to an information processing apparatus including a storage unit and a processor, an information processing method, and a computer-readable recording medium having a program recorded thereon. In particular, the present invention relates to an information processing apparatus, an information processing method, and a computer-readable recording medium having a program recorded thereon, which facilitate user's input of the range of various parameters.

### BACKGROUND ART

An information processing system such as a personal computer accepts an input of a character and a numerical value from a user by means of a keyboard, a mouse and the like. The information processing system may accept range designation from the user in some cases. In other words, the user must input a plurality of numerical values (e.g., numerical values at a start point and an end point) to the information processing system in some cases. Specifically, in order to retrieve data desired by the user, the information processing system may accept an input of a period, an input of a temperature range and an input of a price range.

When the information processing system accepts the range designation, the user needs to input and/or select the plurality of numerical values. In other words, when the user designates the range, a troublesome work is required. In addition, it is difficult for the user to intuitively grasp the size of the numerical range (extent of the numerical range), the position of the numerical range (position of the numerical range with respect to the whole) and the like. Therefore, when retrieving the desired data, the user may perform the range designation a plurality of times until the user finds the desired data.

Thus, a technique for facilitating user's input of the range of various parameters and a technique for facilitating user's intuitive grasp of the size, the position and the like of the numerical range have been proposed.

For example, Japanese Patent Laying-Open No. 2007-310867 (Patent Document 1) discloses a data processing apparatus. According to Japanese Patent Laying-Open No. 2007-310867 (Patent Document 1), the data processing apparatus includes: a data obtaining unit for obtaining dates of a plurality of data including attributes related to the dates; a date representing unit for representing the dates of the data by circumferentially arranging a lapse of months and days from January to December and radially arranging a lapse of years over a plurality of years; and a retrieval range display unit for displaying a sector-shaped retrieval range superimposed on and concentric with the date representing unit so that a user can designate the retrieval range. A central angle of the sector for retrieval range display represents the range of months and days for the data to be retrieved. A radial size of the sector for retrieval range display represents the range of years for the data to be retrieved. The data processing apparatus includes a retrieving unit for retrieving data having the date within the range designated in the retrieval range display unit from the data stored in a data storage unit.

In addition, Japanese Patent Laying-Open No. 2001-350793 (Patent Document 2) discloses a related information display control device for displaying access symbols of information including a document, a graphic and an image in association with one another on a display device. According to Japanese Patent Laying-Open No. 2001-350793 (Patent Document 2), the related information display control device has selecting means for selecting a particular access symbol from a plurality of access symbols associated with one another in advance; concentric circle setting means for setting a plurality of concentric circles to be displayed on a display screen of the display device, with the particular access symbol selected by the selecting means set as a center; access symbol positioning means for positioning another grouped access symbols on a circle closer to the center as a degree of relevance to information about the particular access symbol becomes higher, and in addition, positioning the access symbols on the same circle closer to one another as the degree of relevance to the information becomes higher; and display control means for displaying the particular access symbol and the respective access symbols positioned by the access symbol positioning means on the display screen of the display device.

In addition, Japanese Patent Laying-Open No. 2004-72168 (Patent Document 3) discloses an image processing apparatus that corrects a color tone of an image file. According to Japanese Patent Laying-Open No. 2004-72168 (Patent Document 3), the image processing apparatus includes: a presenting unit for presenting a hue circle formed by annularly arranging colors of different hues; a second presenting unit for presenting a hue adjustment control that can move along an outer circumference of the hue circle in accordance with user's operation; and a corrected value input unit for inputting a corrected value of the hue based on a position of the hue adjustment control.

### Patent Document 1: Japanese Patent Laying-Open No. 2007-310867

### Patent Document 2: Japanese Patent Laying-Open No. 2001-350793

### Patent Document 3: Japanese Patent Laying-Open No. 2004-72168

### DISCLOSURE OF THE INVENTION

### Problems to be Solved by the Invention

In the above information processing system, however, the user needs to input the size and the position of the numerical range separately. In other words, in the above information processing system, only one of the size and the position of the numerical range can be designated in one operation. In other words, when the user wants to change the size of the numerical range, the user needs to perform an operation of changing the extent of the numerical range before or after performing an operation of designating the position of the numerical range.

The present invention has been made to solve the above problems, and a main object of the present invention is to provide an information processing apparatus, an information processing method, and a computer-readable recording medium having a program recorded thereon, which allow user's input of the numerical range with simple operation.

### Means for Solving the Problems

According to an aspect of the present invention, there is provided an information processing apparatus. The information processing apparatus includes: a display control unit for causing a display unit to display a reference circle at a prescribed position and to display a moving graphic to be movable in accordance with a move command from an operation unit; a storage unit for storing a plurality of parameters in association with a position on a circumference of the reference circle; and a range deciding unit for outputting a parameter range corresponding to a portion of the circumference of the reference circle located within the moving graphic, based on a position of the moving graphic.

Preferably, the moving graphic is a circle.

Preferably, the parameters are periodic.

Preferably, the range deciding unit outputs a new parameter range based on the move command, when the moving graphic moves in accordance with the move command.

Preferably, the storage unit stores reference circle data specifying the position and a size of the reference circle as well as moving graphic data specifying the position and a size of the moving graphic. The range deciding unit includes an intersection calculator for calculating information about at least one intersection of the reference circle and the moving graphic, based on the reference circle data and moving graphic data, a parameter calculator for calculating the parameter corresponding to each intersection, based on the information about each intersection, and a range generator for outputting the at least one parameter as a boundary value defining the parameter range.

Preferably, the range deciding unit further includes a determining unit for determining whether or not a center position of the moving graphic is located within a prescribed distance from a center position of the reference circle. The range generator outputs a parameter range corresponding to an entire portion of the circumference of the reference circle, when the center position of the moving graphic is located within the prescribed distance from the center position of the reference circle.

Preferably, when the reference circle is tangent to the moving graphic at one point, the range deciding unit outputs a parameter corresponding to the tangent point.

Preferably, the operation unit accepts a change command to change a size of the moving graphic. The range deciding unit changes the size of the moving graphic based on the change command.

Preferably, when the moving graphic moves away from the reference circle, the range deciding unit increases a radius of the reference circle such that the reference circle becomes tangent to the moving graphic.

Preferably, the operation unit accepts a fix command to fix any one of the intersections. The range deciding unit moves the moving graphic in accordance with the move command, with any one of the intersections fixed based on the fix command.

Preferably, the operation unit accepts a fix command to fix any one of the intersections. The range deciding unit increases or decreases a size of the moving graphic in accordance with the move command, with any one of the intersections fixed based on the fix command.

Preferably, the storage unit stores a plurality of files having attributes corresponding to the parameters. The information processing apparatus further includes an extracting unit for extracting a file having an attribute corresponding to the parameter range from the storage unit and outputting the file, based on the parameter range.

Preferably, the display control unit causes the display unit to display the file extracted by the extracting unit.

Preferably, the file is an image file. The display control unit causes the display unit to display a thumbnail image based on the image file extracted by the extracting unit.

According to still another aspect of the present invention, there is provided an information processing method in an information processing apparatus including a storage unit and a processing device. The information processing method includes the steps of: storing, by the storage unit, a parameter in association with a position on a circumference of a reference circle; causing, by the processing device, a display unit to display the reference circle at a prescribed position and to display a moving graphic to be movable in accordance with a move command from an operation unit; and outputting, by the processing device, a parameter range corresponding to a portion of the circumference of the reference circle located within the moving graphic, based on a position of the moving graphic.

According to still another aspect of the present invention, there is provided a computer-readable recording medium having recorded a program for causing an information processing apparatus including a storage unit and a processing device to output a parameter range. The program causes the processing device to perform the steps of: storing a parameter in the storage unit in association with a position on a circumference of a reference circle; causing a display unit to display the reference circle at a prescribed position and to display a moving graphic to be movable in accordance with a move command from an operation unit; and outputting the parameter range corresponding to a portion of the circumference of the reference circle located within the moving graphic, based on a position of the moving graphic.

### EFFECTS OF THE INVENTION

As described above, according to the present invention, there is provided an information processing apparatus, an information processing method, and a computer-readable recording medium having a program recorded thereon, which allow user's input of the numerical range with simple operation.

### BRIEF DESCRIPTION OF THE DRAWINGS

FIG. 1 is a conceptual view illustrating a screen for designating the range of date displayed on a display unit of an information processing system.

FIG. 2 is a conceptual view illustrating a screen for designating the range of time displayed on the display unit of the information processing system.

FIG. 3 is a perspective view illustrating a computer that is an example of the information processing system according to the present embodiment.

FIG. 4 is a control block diagram illustrating a hardware configuration of the computer that is an example of the information processing system according to the present embodiment.

FIG. 5 is a block diagram illustrating a functional configuration of the computer according to a first embodiment.

FIG. 6 is a conceptual view illustrating the positional relationship between a reference circle and a moving circle represented by data stored in a storage unit.

FIG. 7 is a conceptual view illustrating a data structure of a graphic file stored in the storage unit.

FIG. 8 is a conceptual view illustrating a data structure of an intersection file stored in the storage unit.

FIG. 9A is a conceptual view illustrating a data structure of a date-associated file stored in the storage unit.

FIG. 9B is a conceptual view illustrating a data structure of a time-associated file stored in the storage unit.

FIG. 10 is a conceptual view illustrating a data structure of a range file stored in the storage unit.

FIG. 11 is a conceptual view illustrating the relationship among the reference circle, the moving circle and the parameter range when the distance between the center coordinate of the moving circle and the center coordinate of the reference circle is shorter than a prescribed distance.

FIG. 12 is a conceptual view illustrating the relationship among the reference circle, the moving circle and the parameter range when the distance between the center coordinate of the moving circle and the center coordinate of the reference circle becomes longer than or equal to the prescribed distance.

FIG. 13 is a conceptual view illustrating the relationship among the reference circle, the moving circle and the parameter range when the distance between the center coordinate of the moving circle and the center coordinate of the reference circle is further increased.

FIG. 14 is a conceptual view illustrating the relationship among the reference circle, the moving circle and the parameter range when the moving circle is tangent to the reference circle.

FIG. 15 is a conceptual view illustrating the relationship among the reference circle, the moving circle and the parameter range when the moving circle further moves away from the reference circle.

FIG. 16 is a flowchart illustrating process steps of a range decision process in the computer according to the first embodiment.

FIG. 17 is a first conceptual view illustrating a screen for retrieving a file based on date.

FIG. 18 is a second conceptual view illustrating a screen for retrieving a file based on date.

FIG. 19 is a third conceptual view illustrating a screen for retrieving a file based on time.

FIG. 20 is a block diagram illustrating a functional configuration of a computer according to a second embodiment.

FIG. 21 is a flowchart illustrating process steps of a file retrieval process in the computer according to the second embodiment.

### DESCRIPTION OF THE REFERENCE SIGNS

100 computer; 101 computer main body; 102 monitor; 102a display unit; 102A moving circle; 102E tangent point; 102F retrieval result; 102S reference circle; 103 keyboard; 104 mouse; 105 CPU; 105a, 105a-2 processor; 105b intersection calculator; 105c parameter calculator; 105d range generator; 105e output unit; 105f, 105f-2 display control unit; 105j extracting unit; 105k thumbnail generator; 105m selection accepting unit; 105s range deciding unit; 106 memory; 106a, 106a-2 storage unit; 106b graphic file; 106c intersection file; 106d associated file; 106d-1 date-associated file; 106d-2 time-associated file; 106e range file; 106A image file; 107 fixed disk; 108 internal bus; 109 communication interface; 115 display unit interface; A first intersection; B second intersection; r0 initial radius; r1 radius of reference circle; r2 radius of moving circle; r3 prescribed distance

### BEST MODES FOR CARRYING OUT THE INVENTION

Embodiments of the present invention will be described hereinafter with reference to the drawings. In the following description, the same components are denoted with the same reference characters, and when the names and functions of the components are the same, detailed description of the components will not be repeated.

“Output” refers to a concept including not only an operation of display and print based on data and a signal, but also at least an operation of providing the data and the signal to another program and device. In other words, “output” refers to a concept that also includes an operation of passing the data to another application and the like within a computer and an operation of sending the data through a network.

In addition, “acceptance” and “input” refers to at least an operation of obtaining the data and the signal, and refers to a concept including not only an operation for a processor to accept information from human beings by a keyboard, a mouse, a voice input device and the like, but also to accept the data and the signal from another program and another medium. In other words, “acceptance” and “input” refers to a concept that also includes an operation of accepting the data from another application and the like within the computer and an operation of receiving the data from outside the computer through the network.

### First Embodiment

<Overall Configuration>

First, an overall configuration of an information processing system according to the present embodiment will be described. The information processing system according to the present embodiment accepts an input of the parameter range from a user, and displays information indicating the parameter range, and/or passes the information to another application executed by the information processing system, and/or passes the information to a device external to the information processing system. The information processing system is typically implemented by a computer including an operation unit, a display unit, a processor, and a storage unit, such as a personal computer, a workstation, a PDA (Personal Digital Assistance), and a mobile phone.

The information processing system, however, includes not only a type of system where the operation unit, the display unit, the processor, and the storage unit are mounted on the computer, but also a type of system where the operation unit and the display unit are connected to a computer main body (information processing apparatus) by a cable and the like. In addition, the computer main body of the information processing system includes not only a computer main body of a so-called desktop computer, but also a DVD recorder connected to a television device, a computer main body used for a so-called Internet TV, and the like.

A range decision process performed by the information processing system is implemented by the processor reading a control program stored in the storage unit and executing the control program.

<Overview of Operation>

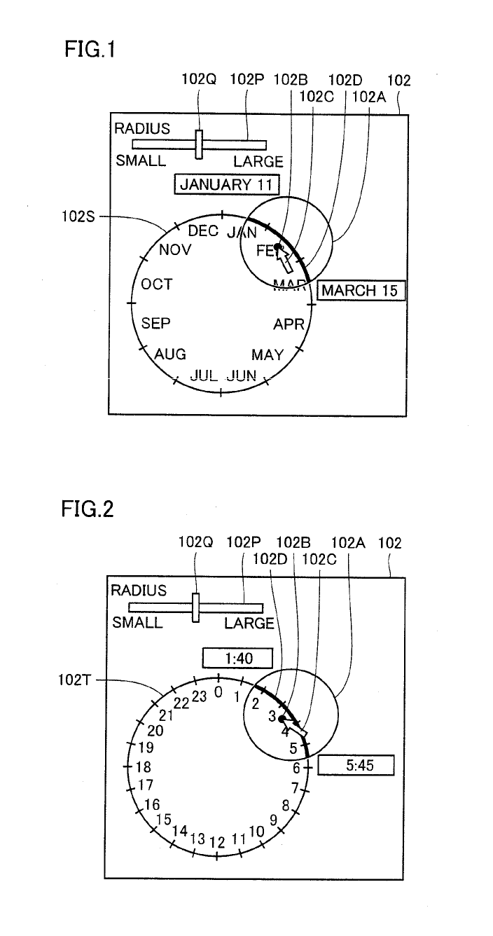

An overview of operation in the information processing system according to the present embodiment will be described. FIG. 1 is a conceptual view illustrating a screen for designating the range of date displayed on a monitor 102 of the information processing system.

As shown in FIG. 1, when the user designates the parameter range, a reference circle 102S indicating the entire parameter range is displayed at a prescribed position on monitor 102. For example, when the user selects a prescribed period of one year, the date (parameter) of one year is associated with each portion of reference circle 102S. In addition, a moving circle 102A for designating the range of a part of the parameter is displayed on monitor 102. The user can move moving circle 102A to various positions with respect to reference circle 102S with a drag and drop operation, for example.

Although the moving graphic moving on monitor 102 has a circular shape in the present embodiment, any moving graphic is possible if it can define an internal region (inside portion) and move on monitor 102. In other words, the moving graphic may have a polygonal shape such as a triangular, rectangular or rhombic shape, or may have a shape corresponding to a type of the designated parameter.

The information processing system obtains the parameter range corresponding to a portion of the circumference of reference circle 102S located within moving circle 102A. In other words, the user can change the range of the circumference of reference circle 102S located within moving circle 102A, by shifting moving circle 102A. As a result, the user can readily change the parameter range.

In particular, in the information processing system according to the present embodiment, the user can change the parameter range (width) by shifting moving circle 102A in the radial direction of reference circle 102S while changing the position of the parameter range by shifting moving circle 102A in the circumferential direction of reference circle 102S.

In this manner, the user can select the desired date and period (such as the number of days) simultaneously and intuitively with one drag and drop operation, for example.

Similarly, FIG. 2 is a conceptual view illustrating a screen for designating the range of time displayed on monitor 102 of the information processing system. As shown in FIG. 2, when the user designates the parameter range, a reference circle 102T indicating the entire parameter range is displayed at a prescribed position on monitor 102. For example, when the user selects a prescribed time of one day, the time (parameter) of one day is associated with each portion of reference circle 102T. In addition, a moving circle 102A for designating the range of a part of the parameter is displayed on monitor 102. The user can move moving circle 102A to various positions with respect to reference circle 102T with the drag and drop operation, for example.

The information processing system obtains the parameter range corresponding to a portion of the circumference of reference circle 102T located within moving circle 102A. In other words, the user can change the range of the circumference of reference circle 102T located within moving circle 102A, by shifting moving circle 102A. As a result, the user can readily change the parameter range.

In particular, in the information processing system according to the present embodiment, the user can change the parameter range (width) by shifting moving circle 102A in the radial direction of reference circle 102T while changing the position of the parameter range by shifting moving circle 102A in the circumferential direction of reference circle 102T.

In this manner, the user can select the desired time and period (time length) simultaneously and intuitively with one drag and drop operation, for example.

A configuration of the information processing system for implementing such operation (range decision process) will be described in detail hereinafter.

<Hardware Configuration>

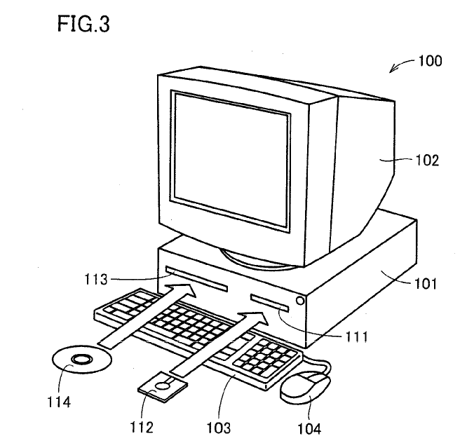

FIG. 3 is a perspective view illustrating a computer 100 that is an example of the information processing system according to the present embodiment. As shown in FIG. 3, this computer 100 includes a computer main body 101 having an FD (Flexible Disk) drive device 111 and a CD-ROM (Compact Disk-Read Only Memory) drive device 113, monitor 102, a keyboard 103, and a mouse 104.

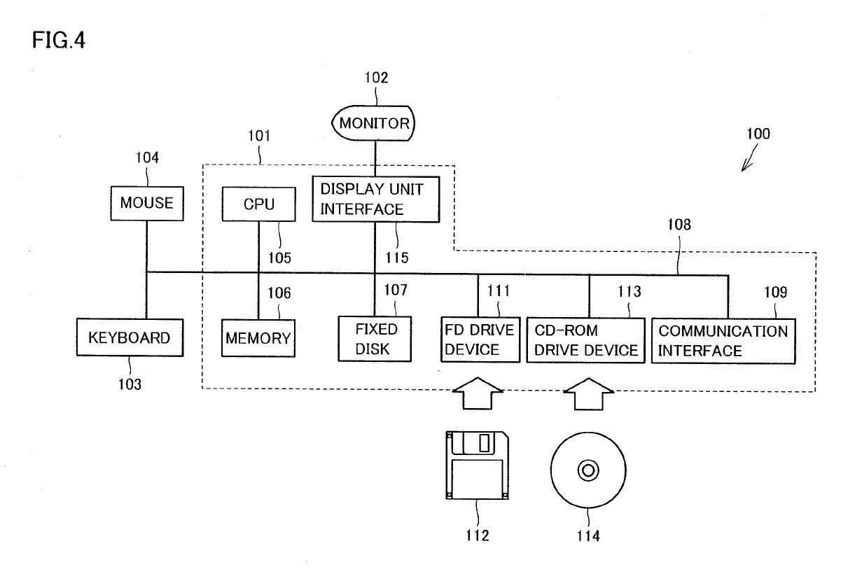

FIG. 4 is a control block diagram illustrating a hardware configuration of computer 100 that is an example of the information processing system according to the present embodiment. As shown in FIG. 4, in addition to FD drive device 111 and CD-ROM drive device 113 described above, computer main body 101 includes a CPU (Central Processing Unit) 105, a memory 106 such as an RAM (Random access memory), a fixed disk 107 such as an HDD (Hard Disk Drive), and a communication interface 109, which are mutually connected by an internal bus 108. An FD 112 is loaded into FD drive device 111. A CD-ROM 114 is loaded into CD-ROM drive device 113.

Monitor 102 is configured by a liquid crystal panel and a CRT, and displays information output by CPU 105. Keyboard 103 accepts information from the user by means of key input. Mouse 104 accepts information from the user by means of click or slide. Memory 106 stores various information and temporarily stores data that is required to execute a program in CPU 105, for example. Fixed disk 107 stores the program executed by CPU 105 and a database.

CPU 105 is a device that controls each element of computer 100 and makes various calculations. In addition, CPU 105 performs the range decision process, and stores the result of the process in a prescribed region of memory 106, and/or outputs the result of the process to monitor 102 through internal bus 108, and/or sends the result of the process to an external device through communication interface 109.

Communication interface 109 is a device that converts the information output by CPU 105 to an electrical signal, that is, converts the information output by CPU 105 to a signal that can be used by other devices. In addition, communication interface 109 is also a device that receives a signal input from outside computer 100 according to the present embodiment and converts the signal to information that can be used by CPU 105. Other output devices such as a printer can be connected to computer 100 as required. For example, CPU 105 causes monitor 102 to display information through a display unit interface 115.

As already described, the information processing system and the range decision process according to the present embodiment are implemented by hardware such as computer 100 and software such as the control program. Generally, such software is distributed through the network and the like or by a recording medium such as FD 112 and CD-ROM 114 having the software stored therein. The software is read from the recording medium by FD drive device 111, CD-ROM drive device 113 and the like, or received at communication interface 109, and stored in fixed disk 107. The software is read from fixed disk 107 to memory 106 and executed by CPU 105.

<Functional Configuration>

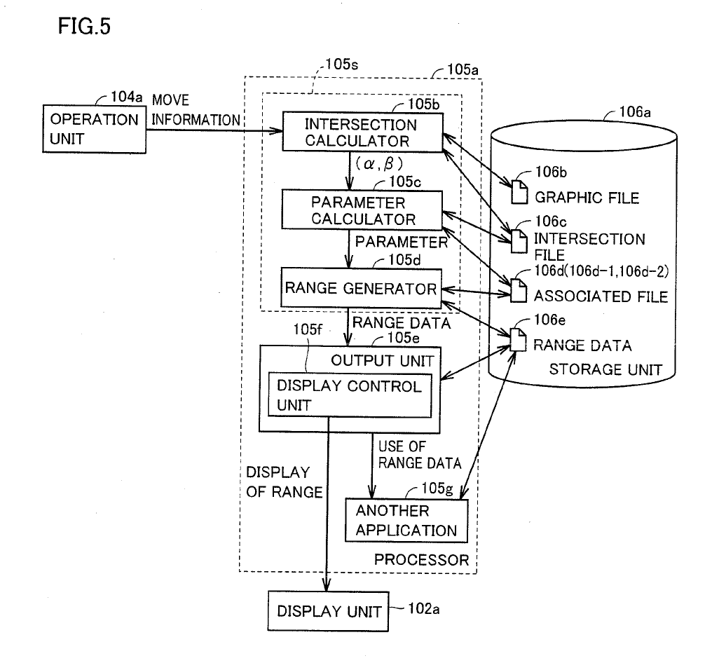

Next, each function of computer 100 according to the present embodiment will be described. FIG. 5 is a block diagram illustrating a functional configuration of computer 100 according to the present embodiment. As shown in FIG. 5, computer 100 according to the present embodiment includes an operation unit 104a, a processor 105a, a storage unit 106a, and a display unit 102a.

Operation unit 104a is implemented by, for example, keyboard 103, mouse 104 and the like. Operation unit 104a accepts a move command to move moving circle 102A from the user. More specifically, operation unit 104a inputs, to processor 105a, information indicating a motion vector corresponding to the amount of movement of mouse 104.

Display unit 102a is implemented by monitor 102 and the like. Display unit 102a displays an image, a text and the like based on data from processor 105a.

Storage unit 106a is implemented by, for example, memory 106, fixed disk 107 and the like. Storage unit 106a stores a graphic file 106b that stores information indicating the position coordinate and the radius of reference circle 102S as well as information indicating the initial position coordinate, the initial radius, the current position coordinate, and the current radius of moving circle 102A. Storage unit 106a stores an intersection file 106c that stores a coordinate of an intersection of reference circle 102S and moving circle 102A. Storage unit 106a stores an associated file 106d (106d-1, 106d-2) in which each portion on the circumference of reference circle 102S and the parameter are associated and stored. Storage unit 106a stores a range file 106e that stores information indicating the parameter range.

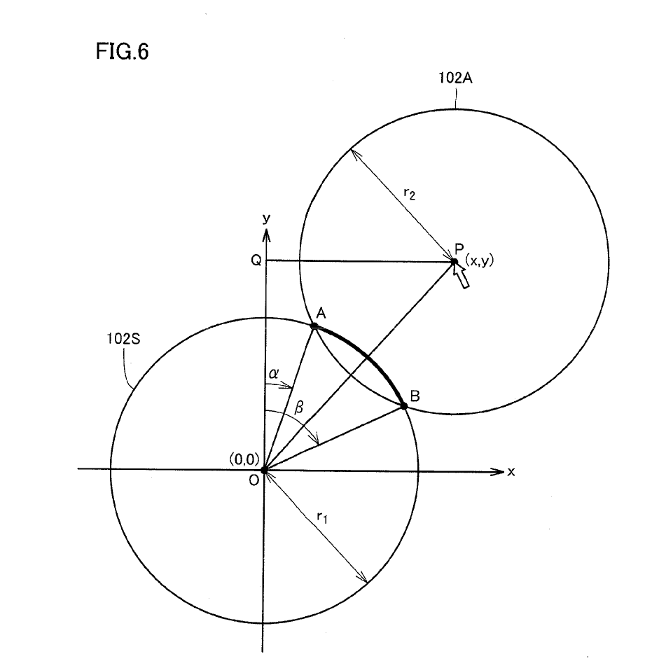

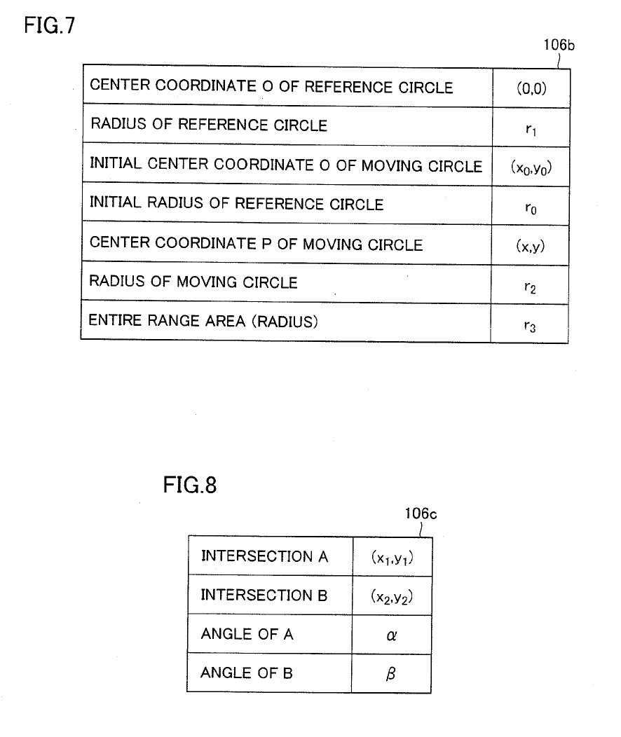

FIG. 6 is a conceptual view illustrating the positional relationship between reference circle 102S and moving circle 102A represented by the data stored in storage unit 106a. FIG. 7 is a conceptual view illustrating a data structure of graphic file 106b stored in storage unit 106a. As shown in FIGS. 6 and 7, graphic file 106b stores a center coordinate O (0, 0) of reference circle 102S, a radius r1 of reference circle 102S, an initial center coordinate O (x0, x0) of moving circle 102A when the range decision process starts, an initial radius r0 of moving circle 102A when the range decision process starts, a current center coordinate P (x, y) of moving circle 102A, a current radius r2 of moving circle 102A, and a radius (prescribed distance r3) indicating an area for selecting the entire range.

When the distance between center coordinate O (0, 0) of reference circle 102S and current center coordinate P (x, y) of moving circle 102A is within prescribed distance r3, processor 105a according to the present embodiment considers that the entire parameter range is selected. The radius indicating the area for selecting the entire range is set as prescribed distance r3 in advance.

FIG. 8 is a conceptual view illustrating a data structure of intersection file 106c stored in storage unit 106a. As shown in FIGS. 6 and 8, intersection file 106c stores a coordinate (x1, y1) of a first intersection A as well as a coordinate (x2, y2) of a second intersection B of reference circle 102S and moving circle 102A. In addition, intersection file 106c stores an angle α between a reference axis (y axis in the present embodiment) and a straight line connecting center coordinate O (0, 0) of reference circle 102S and first intersection A (x1, y1). Here, the reference axis refers to an axis passing through center coordinate O (0, 0) of reference circle 102S for indicating, for example, the lowest position of the parameter, and refers to the y axis in the present embodiment. In addition, intersection file 106c stores an angle β between the reference axis and a straight line connecting center coordinate O (0, 0) of reference circle 102S and second intersection B (x2, y2).

When angles α and β are directly worked out without calculating the coordinate (x1, y1) of first intersection A and the coordinate (x2, y2) of second intersection B as will be described later, intersection file 106c does not need to store the coordinate (x1, y1) of first intersection A and the coordinate (x2, y2) of second intersection B.

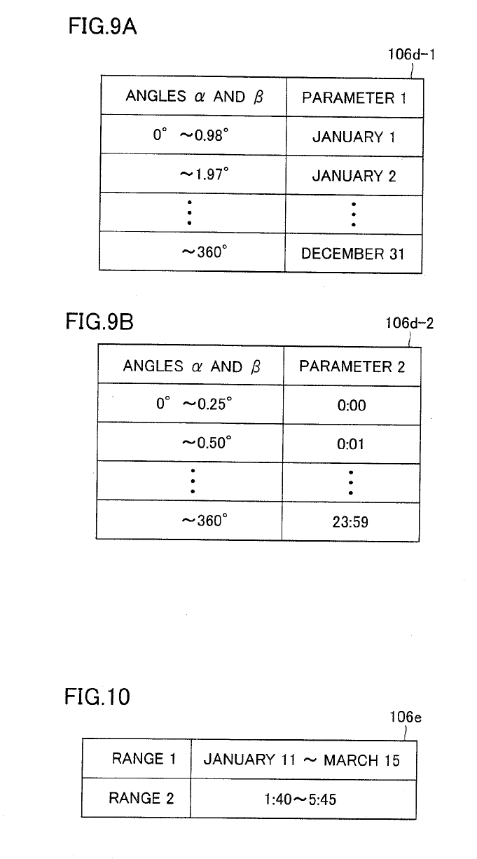

FIG. 9A is a conceptual view illustrating a data structure of a date-associated file 106d-1 stored in storage unit 106a. FIG. 9B is a conceptual view illustrating a data structure of a time-associated file 106d-2 stored in storage unit 106a.

As shown in FIGS. 6 and 9A, date-associated file 106d-1, for example, stores angles α and β corresponding to respective portions of the circumference of reference circle 102S whose entire circumference corresponds to one year, in association with a date parameter. In other words, date-associated file 106d-1 stores the range of angles α, β corresponding to each date parameter.

As shown in FIGS. 6 and 9B, time-associated file 106d-2 stores angles α and β corresponding to respective portions of the circumference of reference circle 102S whose entire circumference corresponds to one day, in association with a time parameter. In other words, time-associated file 106d-2 stores the range of angles α, β corresponding to each time parameter.

FIG. 10 is a conceptual view illustrating a data structure of range file 106e stored in storage unit 106a. As shown in FIG. 10, range file 106e, for example, stores a date parameter corresponding to angle α and a date parameter corresponding to angle β as the date range selected by the user. In addition, range file 106e, for example, stores a time parameter corresponding to angle α and a time parameter corresponding to angle β as the time range selected by the user.

It is noted that each of files 106b, 106c, 106d-1, 106d-2, and 106e described above does not need to store all data described above, but may have a configuration in which a part thereof is stored by another file (different file). In other words, the file structure (data structure) may have a configuration different from the above configuration.

Returning to FIG. 5, processor 105a is implemented by CPU 105 and the like. Processor 105a has functions such as a range deciding unit 105s, an output unit 105e and the like. Range deciding unit 105s includes an intersection calculator 105b, a parameter calculator 105c and a range generator 105d. Output unit 105e includes a display control unit 105f.

More specifically, each function of processor 105a is implemented by CPU 105 executing the control program stored in memory 106, fixed disk 107 and the like, and controlling each hardware shown in FIGS. 3 and 4. Although a configuration is described in the present embodiment in which the function for performing the range decision process is implemented by the software running on CPU 105, the function of each block and the process in each step may be implemented by a dedicated hardware circuit and the like instead of the software.

Processor 105a causes display unit 102a to display reference circle 102S arranged at a prescribed position and moving circle 102A moving in accordance with the move command from operation unit 104a. When moving circle 102A is moved by means of operation unit 104a, processor 105a calculates the parameter range corresponding to the portion of the circumference of reference circle 102S located within moving circle 102A, based on the position of moving circle 102A. Processor 105a stores the result of the calculation in storage unit 106a for use in another application, and/or outputs the result of the calculation to display unit 102a.

Each function of processor 105a will be described hereinafter. As shown in FIGS. 5 and 6, intersection calculator 105b calculates angle α and angle β based on reference circle data and moving circle data stored in graphic file 106b. Intersection calculator 105b stores the values of angle α and angle β in intersection file 106c. A method for calculating angle α and angle β by intersection calculator 105b will be described hereinafter.

First, intersection calculator 105b calculates ∠QOP based on the following equation (1). Here, a point Q is a point on a straight line connecting a center of reference circle 102S and a point on the circumference of reference circle 102S corresponding to the minimum value of the parameter, and a point at which ∠PQO forms a right angle.

$$\begin{matrix}[ Equation 1 ] & \\ ∠ QOP = {tan}^{- 1} ( \frac{x}{y} ) & ( 1 )\end{matrix}$$

Next, intersection calculator 105b can derive the following equation (3) based on the cosine theorem, that is, the following equation (2), and calculates ∠AOP based on equation (3).

$$\begin{matrix}[ Equation 2 ] & \\ cos ∠ AOP = \frac{{OA}^{2} + {OP}^{2} - {AP}^{2}}{2 \cdot OA \cdot OP} & ( 2 ) \\ [ Equation 3 ] & \\ ∠ AOP = {cos}^{- 1} ( \frac{{OA}^{2} + {OP}^{2} - {AP}^{2}}{2 \cdot OA \cdot OP} ) = {cos}^{- 1} ( \frac{{r}_{1}^{2} + {x}^{2} + {y}^{2} - {r}_{2}^{2}}{2 \cdot {r}_{1} \cdot \sqrt{{x}^{2} + {y}^{2}}} ) & ( 3 )\end{matrix}$$

As a result, intersection calculator 105b can calculate angle α based on the following equation (4).

[Equation 4]

α=∠QOP−∠AOP (4)

In addition, since a triangle AOP and a triangle BOP are congruent, intersection calculator 105b can calculate angle β based on the following equation (5).

[Equation 5]

β=∠QOP+∠AOP 5)

As will be described hereinafter, however, intersection calculator 105b may calculate the coordinate (x1, y1) of intersection A and the coordinate (x2, y2) of intersection B, and then, calculate angle α and angle β based on the coordinate (x1, y1) of intersection A and the coordinate (x2, y2) of intersection B.

In other words, intersection calculator 105b calculates the coordinate (x1, y1) of intersection A and the coordinate (x2, y2) of intersection B of reference circle 102S and moving circle 102A based on the reference circle data and the moving circle data stored in graphic file 106b. Intersection calculator 105b stores the coordinate (x1, y1) of intersection A and the coordinate (x2, y2) of intersection B in intersection file 106c. Intersection calculator 105b calculates angle α based on the coordinate (x1, y1) of intersection A, and calculates angle β based on the coordinate (x2, y2) of intersection B. Intersection calculator 105b stores the values of angle α and angle β in intersection file 106c.

For example, intersection calculator 105b calculates angle α and angle β based on the following equation (6) and equation (7).

$$\begin{matrix}[ Equation 6 ] & \\ α = {tan}^{- 1} ( \frac{{x}_{1}}{{y}_{1}} ) & ( 6 ) \\ [ Equation 7 ] & \\ β = {tan}^{- 1} ( \frac{{x}_{2}}{{y}_{2}} ) & ( 7 )\end{matrix}$$

Then, parameter calculator 105c calculates parameters corresponding to intersections A and B (angles α and β), based on angle α corresponding to intersection A and angle β corresponding to intersection B. More specifically, referring to associated files 106d-1 and 106d-2, parameter calculator 105c reads a date parameter, a time parameter or the like corresponding to angle α. In addition, referring to associated files 106d-1 and 106d-2, parameter calculator 105c reads a date parameter or a time parameter corresponding to angle β.

A configuration in which processor 105a calculates the parameters from angles α and β by using associated files 106d-1 and 106d-2 has been described here in connection with the example in which the parameter selected by the user is periodic like date (month/day) and time (hour/minute/second). It is also possible, however, to work out the parameters without using associated files 106d-1 and 106d-2. For example, when the parameter associated with the circumference of reference circle 102S is a numerical value such as temperature and price, that is, when the user selects the temperature range or the price range, storage unit 106a may store only the minimum value and the maximum value of the parameter that can be selected by the user, in advance.

Specifically, the case will be described where a parameter associated with the entire circumference of reference circle 102S is 100 to 200, that is, where a parameter corresponding to a portion of the circumference of reference circle 102S where the angle is 0° (a portion where the reference axis intersects reference circle 102S) is 100. When angles α and β calculated by intersection calculator 105b are 22.5° and 67.5°, respectively, parameter calculator 105c can calculate parameters corresponding to angles α and β based on the following equation (8) and equation (9), without using associated files 106d-1 and 106d-2.

[Equation 8]

Parameter corresponding to angle α=(22.5÷360)×(200−100)+100=106.25 (8)

[Equation 9]

Parameter corresponding to angle β=(67.5÷360)×(200−100)+100=118.75 (9)

Range generator 105d outputs the parameters corresponding to intersections A and B (range data) as the parameter range selected by the user. More specifically, range generator 105d passes the range data to display control unit 105f. Display control unit 105f causes display unit 102a to display the parameter range through display unit interface 115. In addition, range generator 105d stores the range data in the prescribed region of memory 106 for another application and the like.

More specifically, display control unit 105f is a function included in output unit 105e. In other words, output unit 105e stores the range data received from range generator 105d in the prescribed region of memory 106 for another application and the like, and/or outputs the range data to another device through various interfaces, and/or causes, as display control unit 105f, display unit 102a to display the parameter range selected by the user, based on the range data.

In addition, operation unit 104a accepts a change command to change the size of radius r2 of moving circle 102A. Specifically, as shown in FIGS. 1 and 2, a scale 102P and a slider 102Q for changing the size of radius r2 of moving circle 102A are displayed on display unit 102a. By operating (sliding) slider 102Q, the user inputs the command to change radius r2 of moving circle 102A to processor 105a. Processor 105a (range deciding unit 105s) updates the value of radius r2 of moving circle 102A stored in graphic file 106b, based on the change command.

Referring to FIG. 5, processor 105a (range deciding unit 105s) further includes a determining unit for determining whether or not current center coordinate P (x, y) of moving circle 102A is located within prescribed distance r3 from center coordinate O (0, 0) of reference circle 102S. In computer 100 according to the present embodiment, intersection calculator 105b performs the determination process. When center coordinate P (x, y) of moving circle 102A is located within prescribed distance r3 from center coordinate O of reference circle 102S, range generator 105d considers that the entire circumference of reference circle 102S is selected by the user, and outputs the range data corresponding to the entire circumference of reference circle 102S. Processor 105a (range deciding unit 105s), however, may include a not-shown determining unit, separately from intersection calculator 105b.

In addition, when reference circle 102S is tangent to moving circle 102A at one point, processor 105a (range deciding unit 105s) outputs one parameter corresponding to the tangent point as the range data. In computer 100 according to the present embodiment, intersection calculator 105b determines whether or not reference circle 102S is tangent to moving circle 102A at one point, that is, whether or not OP=r1+r2. When reference circle 102S is tangent to moving circle 102A at one point, range generator 105d outputs the one parameter corresponding to the tangent point as the range data.

In addition, when moving circle 102A moves away from reference circle 102S, processor 105a (range deciding unit 105s) increases r1 of reference circle 102S such that reference circle 102S becomes tangent to moving circle 102A. In computer 100 according to the present embodiment, intersection calculator 105b determines whether or not moving circle 102A is away from reference circle 102S, that is, whether or not OP>r1+r2. When moving circle 102A is away from reference circle 102S, range generator 105d may increase radius r1 of reference circle 102S in graphic file 106b to r1=OP−r2.

In this case, it is preferable that graphic file 106d stores the initial radius and the current radius concerning radius r1 of reference circle 102S as well.

In addition, operation unit 104a accepts a fix command to fix any one of the intersections. For example, by pressing a first prescribed key of operation unit 104a (keyboard 103), the user inputs, to processor 105a (range deciding unit 105s), a command to fix the position of first intersection A. For example, by pressing a second prescribed key of operation unit 104a (keyboard 103), the user inputs, to processor 105a, a command to fix the position of second intersection B. The user inputs, to processor 105a, the command to move moving circle 102A through operation unit 104a (mouse 104) while pressing the first or second prescribed key.

As a result, processor 105a moves moving circle 102A with any one of the intersections fixed. More specifically, processor 105a (range deciding unit 105s) moves the center position of moving circle 102A, that is, updates center coordinate P (x, y) of moving circle 102A in graphic file 106b, with any one of the intersections set as the center. Alternatively, processor 105a increases or decreases the radius of moving circle 102A with any one of the intersections remaining fixed. In other words, processor 105a updates radius r2 of moving circle 102A in graphic file 106b.

To put another way, processor 105a accepts the command to move center coordinate P (x, y) of moving circle 102A from the user, in a state where processor 105a has accepted the command to fix the intersection from the user. Based on the command, processor 105a changes at least any one of center coordinate P (x, y) and radius r2 of moving circle 102A, with the intersection remaining fixed.

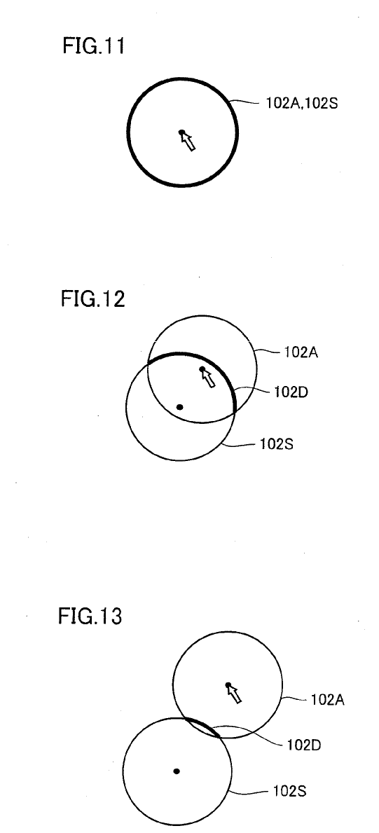

FIG. 11 is a conceptual view illustrating the relationship among reference circle 102S, moving circle 102A and the parameter range when the distance between center coordinate P (x, y) of moving circle 102A and center coordinate O (0, 0) of reference circle 102S is shorter than prescribed distance r3. As shown in FIG. 11, when the distance between center coordinate P (x, y) of moving circle 102A and center coordinate O (0, 0) of reference circle 102S is shorter than prescribed distance r3, that is, when the two center coordinates are close, processor 105a considers that the entire circumference of reference circle 102S is selected by moving circle 102A.

FIG. 12 is a conceptual view illustrating the relationship among reference circle 102S, moving circle 102A and the parameter range when the distance between center coordinate P (x, y) of moving circle 102A and center coordinate O (0, 0) of reference circle 102S becomes longer than or equal to prescribed distance r3. As shown in FIG. 12, processor 105a outputs a parameter corresponding to a portion of the circumference of reference circle 102S located within moving circle 102A, by calculating angle α and angle β. In FIG. 12, a wide range 102D (corresponding to a long period) in the upper right of reference circle 102S is selected by moving circle 102A.

FIG. 13 is a conceptual view illustrating the relationship among reference circle 102S, moving circle 102A and the parameter range when the distance between center coordinate P (x, y) of moving circle 102A and center coordinate O (0, 0) of reference circle 102S is further increased. As shown in FIG. 13, processor 105a outputs a parameter corresponding to a portion of the circumference of reference circle 102S located within moving circle 102A, by calculating angle α and angle β. In FIG. 13, narrow range 102D (corresponding to a short period) in the upper right of reference circle 102S is selected by moving circle 102A.

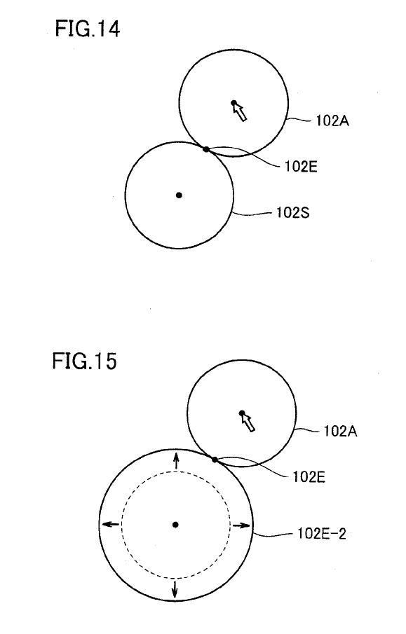

FIG. 14 is a conceptual view illustrating the relationship among reference circle 102S, moving circle 102A and the parameter range when moving circle 102A is tangent to reference circle 102S. As shown in FIG. 14, processor 105a outputs a parameter corresponding to a tangent point 102E of moving circle 102A and reference circle 102S, by calculating one angle α (∠QOP in FIG. 6). In FIG. 14, only tangent point 102E in the upper right of reference circle 102S is selected by moving circle 102A.

FIG. 15 is a conceptual view illustrating the relationship among reference circle 102S, moving circle 102A and the parameter range when moving circle 102A further moves away from reference circle 102S. As shown in FIG. 15, processor 105a increases radius r1 of reference circle 102S such that reference circle 102S becomes tangent to moving circle 102A. In FIG. 15, processor 105a outputs a parameter corresponding to tangent point 102E of moving circle 102A and reference circle 102S, by calculating one angle α (∠QOP in FIG. 6), as in FIG. 14. In FIG. 15, only tangent point 102E in the upper right of reference circle 102S is selected by moving circle 102A.

<Range Decision Process>

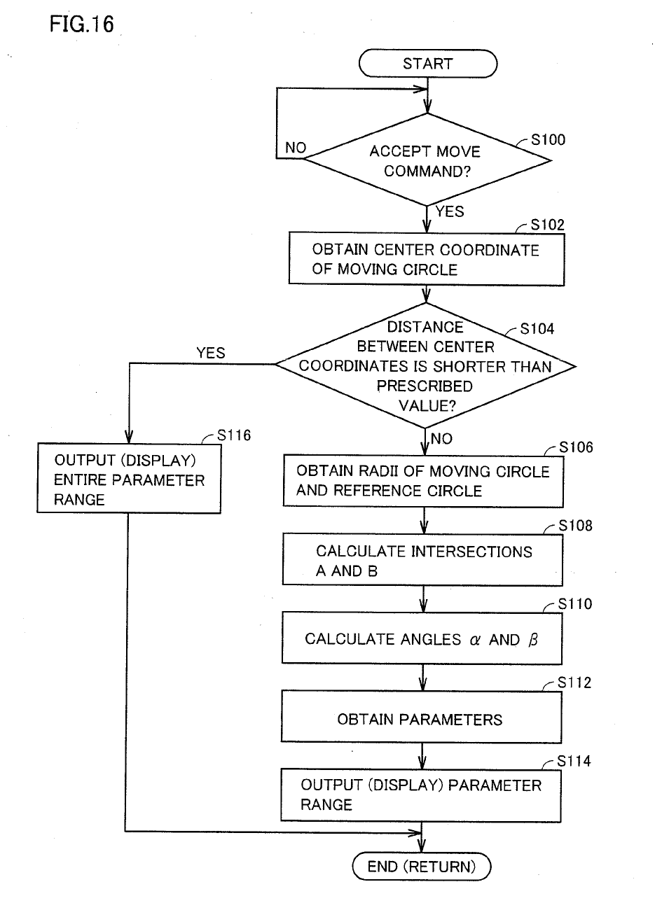

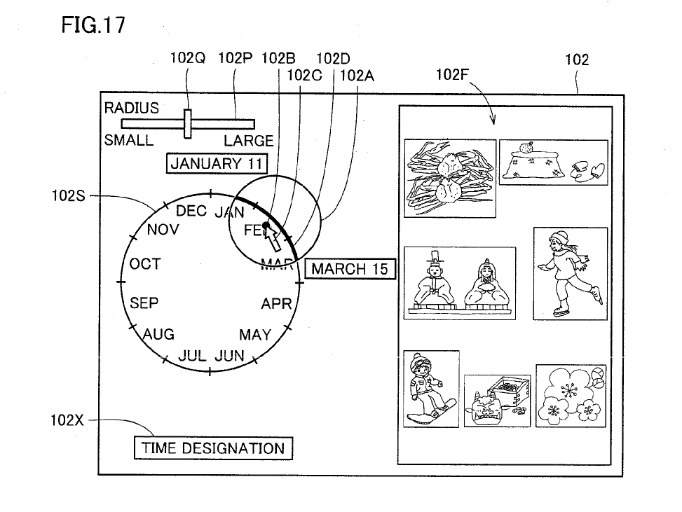

Next, process steps of the range decision process in computer 100 according to the present embodiment will be described. FIG. 16 is a flowchart illustrating the process steps of the range decision process in computer 100 according to the present embodiment.

As shown in FIG. 16, CPU 105 determines whether or not the move command to move moving circle 102A has been accepted through mouse 104 (step S100). When the move command has been accepted (YES in step S100), CPU 105 calculates a new center coordinate P (x, y) based on the motion vector included in the move command and center coordinate P (x, y) of moving circle 102A stored in graphic file 106b (step S102). Then, CPU 105 updates center coordinate P (x, y) of moving circle 102A in graphic file 106b based on new center coordinate P (x, y).

Next, CPU 105 determines whether or not the distance between center coordinate P (x, y) of moving circle 102A and center coordinate O (0, 0) of reference circle 102S is shorter than prescribed distance r3 (step S104). When the distance between center coordinate P (x, y) of moving circle 102A and center coordinate O (0, 0) of reference circle 102S is shorter than prescribed distance r3 (YES in step S104), CPU 105 outputs the parameter corresponding to the entire circumference of reference circle 102S (step S116).

On the other hand, when the distance between center coordinate P (x, y) of moving circle 102A and center coordinate O (0, 0) of reference circle 102S is not shorter than prescribed distance r3 (NO in step S104), CPU 105 reads radius r2 of moving circle 102A and radius r1 of reference circle 102S, referring to graphic file 106b (step S106). Then, CPU 105 works out the coordinate (x1, y1) of intersection A and the coordinate (x2, y2) of intersection B (step S108). CPU 105 calculates angle α and angle β based on the coordinate (x1, y1) of intersection A and the coordinate (x2, y2) of intersection B (step S110).

CPU 105, however, may directly work out angle α and angle β of moving circle 102A based on center coordinate P (x, y), center coordinate O (0, 0) of reference circle 102S, radius r2 of moving circle 102A, and radius r1 of reference circle 102S, without calculating the coordinate (x1, y1) of intersection A and the coordinate (x2, y2) of intersection B, that is, without performing the process in step S108 (step S110).

Then, referring to associated files 106d-1 and 106d-2, for example, CPU 105 obtains the parameter corresponding to angle α and the parameter corresponding to angle β (step S112), and outputs these parameters as the parameter range (range data). In other words, CPU 105 stores the range data in range file 106e, and/or stores the range data in the prescribed region designated by another application, and/or causes display unit 102a to display the parameter range based on the range data (step S114).

### Second Embodiment

Next, a second embodiment of the present invention will be described. In the information processing system according to the above first embodiment, the range data is stored in the prescribed region designated by another application, and/or the parameter range is displayed. On the other hand, in an information processing system according to the present embodiment, a file stored in a storage unit is retrieved by using the range data and the result of the retrieval is displayed.

An overall configuration of the information processing system according to the present embodiment is similar to that of the first embodiment, and thus, description thereof will not be repeated.

<Overview of Operation>

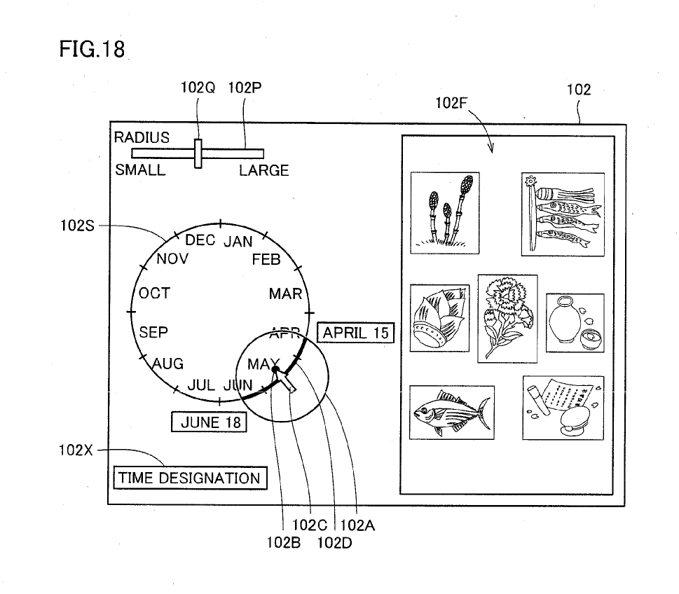

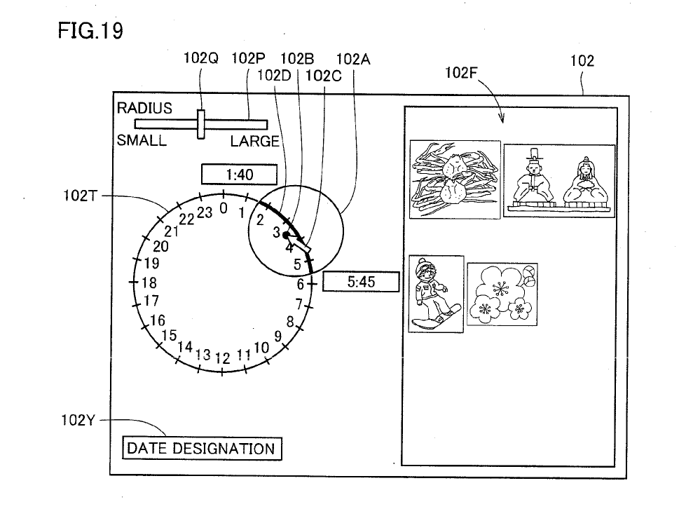

The overview of operation in the information processing system according to the present embodiment will be described hereinafter. Description of each operation similar to that in the first embodiment, however, will not be repeated. FIG. 17 is a first conceptual view illustrating a screen for retrieving a file based on date. FIG. 18 is a second conceptual view illustrating a screen for retrieving a file based on date. FIG. 19 is a third conceptual view illustrating a screen for retrieving a file based on time.

As shown in FIGS. 17 and 18, when the user selects a prescribed period of one year, for example, the information processing system according to the present embodiment retrieves a file corresponding to the prescribed period from the storage unit. Not only reference circle 102S and moving circle 102A but also a retrieval result 102F is displayed on monitor 102.

For example, when the user selects a date period from January 11 to March 15 (winter period in Japan) by shifting moving circle 102A on reference circle 102S as shown in FIG. 17, the information processing system retrieves an image file and the like corresponding to the date period from the storage unit. Then, the information processing system causes monitor 102 to display a thumbnail image corresponding to the retrieved image file (retrieval result 102F).

When the user selects a date period from April 15 to June 18 (spring period in Japan) as shown in FIG. 18, the information processing system retrieves an image file and the like corresponding to the date period from the storage unit. Then, the information processing system causes monitor 102 to display a thumbnail image corresponding to the retrieved image file.

In addition, from the data retrieved based on date, the information processing system further retrieves data based on time. In other words, after the information processing system retrieves (extracts) data based on date, the user inputs a command to perform retrieval based on time to the information processing system. Specifically, when the user presses (clicks) a time designation button 102X displayed on monitor 102, a screen for selecting time is displayed on monitor 102 as shown in FIG. 19.

For example, when the user selects time from 1:40 to 5:45 by shifting moving circle 102A on reference circle 102S again as shown in FIG. 19, the information processing system retrieves an image file and the like corresponding to the time from the storage unit. Then, the information processing system causes monitor 102 to display a thumbnail image corresponding to the retrieved image file.

A configuration of the information processing system for implementing such operation (file retrieval process) will be described in detail hereinafter. A hardware configuration of computer 100 that is an example of the information processing system, however, is similar to that of the first embodiment, and thus, description thereof will not be repeated.

<Functional Configuration>

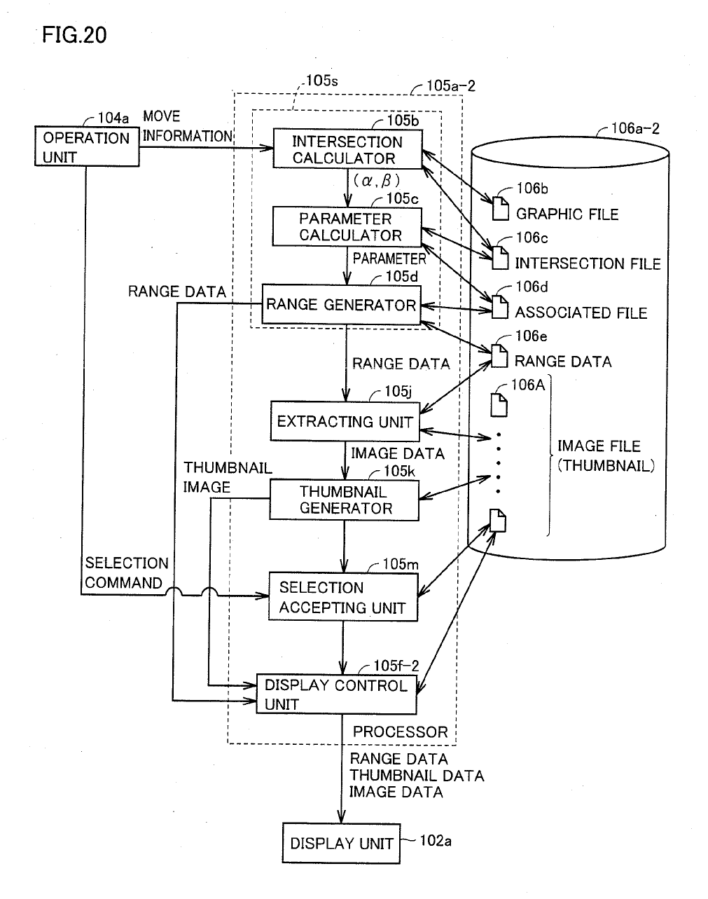

Each function of computer 100 according to the present embodiment will be described hereinafter. It is noted that description of the functions similar to those in the first embodiment will not be repeated. FIG. 20 is a block diagram illustrating a functional configuration of computer 100 according to the present embodiment. As shown in FIG. 20, computer 100 according to the present embodiment includes operation unit 104a, a processor 105a-2, a storage unit 106a-2, and display unit 102a.

Storage unit 106a-2 according to the present embodiment stores not only graphic file 106b, intersection file 106c, associated file 106d (106d-1, 106d-2), and range file 106e, but also a plurality of viewed files. The viewed file refers to, for example, a static image file, a moving image file, a text file, a music file and the like. In the following, in the present embodiment, an image file 106A will be typically described as the viewed file.

Each image file 106A includes various attribute information. Specifically, image file 106A includes information about the date and time when the image was taken (or generated or updated), the amount of data, information indicating the type of the image, and the like. In addition, the image file may include meta information including other attribute information.

Processor 105a-2 is implemented by CPU 105 and the like. Processor 105a-2 has functions such as range deciding unit 105s, an extracting unit 105j, a thumbnail generator 105k, a selection accepting unit 105m, and a display control unit 105f-2. Range deciding unit 105s includes intersection calculator 105b, parameter calculator 105c and range generator 105d. Display control unit 105f-2 may, however, be configured to have functions such as extracting unit 105j, thumbnail generator 105k and selection accepting unit 105m.

More specifically, each function of processor 105a-2 is implemented by CPU 105 executing the control program stored in memory 106, fixed disk 107 and the like, and controlling each hardware shown in FIGS. 3 and 4, as described above. Although the configuration is described in the present embodiment in which the function for performing the range decision process is implemented by the software running on CPU 105, the function of each block and the process in each step may be implemented by the dedicated hardware circuit and the like instead of the software.

Based on the parameter range (range data) passed from range generator 105d, extracting unit 105j retrieves and extracts image file 106A whose attribute value is included in the parameter range, referring to storage unit 106a-2. For example, when the parameter range indicates a period specified based on two dates, extracting unit 105j retrieves and extracts the image file taken within the period.

Thumbnail generator 105k obtains thumbnail image data based on each extracted image file 106A. Specifically, thumbnail generator 105k generates the thumbnail image data based on the data included in each extracted image file 106A. Alternatively, thumbnail generator 105k extracts the thumbnail image data from the data included in each image file 106A. Thumbnail generator 105k passes the thumbnail image data to display control unit 105f-2.

Then, display control unit 105f-2 causes display unit 102a to selectively display the thumbnail image as retrieval result 102F based on each thumbnail image data, as shown in FIGS. 17 to 19.

Selection accepting unit 105m accepts, through operation unit 104a, a command to select the thumbnail image displayed on display unit 102a. Selection accepting unit 105m reads image file 106A from storage unit 106a-2 based on the selection command.

Then, display control unit 105f-2 causes display unit 102a to display an image of the original image size, based on image file 106A read by selection accepting unit 105m.

<File Retrieval Process>

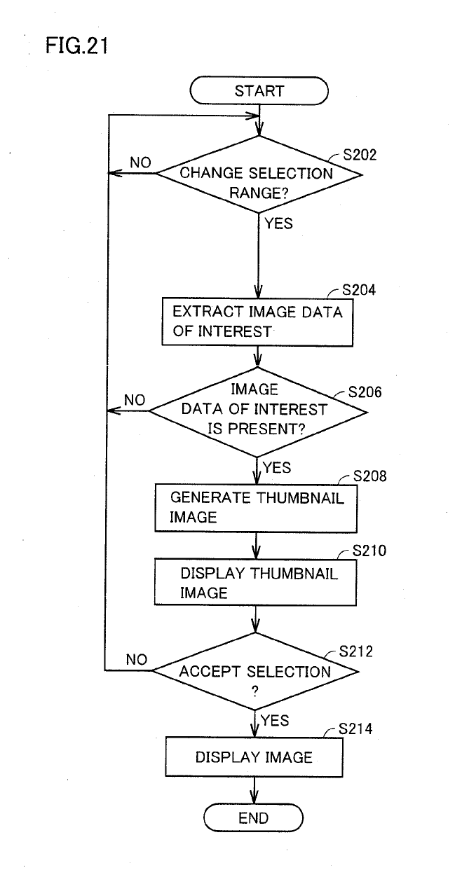

Next, process steps of the file retrieval process in computer 100 according to the present embodiment will be described. FIG. 21 is a flowchart illustrating the process steps of the file retrieval process in computer 100 according to the present embodiment.

As shown in FIG. 21, CPU 105 determines whether or not the range output process (S100) shown in FIG. 16 has been performed (step S202). In other words, CPU 105 determines whether or not the data (range data) in range file 106e has been updated. When the range data has been updated (YES in step S202), CPU 105 extracts image file 106A having an attribute included in the range data from storage unit 106a-2 (step S204).

When CPU 105 cannot extract image file 106A having the attribute included in the range data from storage unit 106a-2 (NO in step S206), CPU 105 repeats the process from step S202. On the other hand, when CPU 105 has extracted image file 106A having the attribute included in the range data from storage unit 106a-2 (NO in step S206), CPU 105 obtains the thumbnail image data based on image file 106A (step S208). Then, CPU 105 causes monitor 102 to display the thumbnail image as retrieval result 105F based on the thumbnail image data (step S210).

Then, CPU 105 accepts, from operation unit 104a, the command to select the thumbnail image (step S212). When CPU 105 has accepted the command to select the thumbnail image (YES in step S212), CPU 105 extracts image file 106A corresponding to the thumbnail image from storage unit 106a-2, and causes display unit 102a to display the image of the original image size based on image file 106A (step S214).

On the other hand, when CPU 105 has not accepted the selection of the thumbnail image (NO in step S212), CPU 105 repeats the process from step S202.

### Other Embodiments

The program according to the present invention may be such that a required module in program modules offered as a part of the operating system (OS) of the computer is called in a prescribed array and at a prescribed timing, and performs the process. In this case, a program itself does not include the above module and the process is performed in cooperation with the OS. The program according to the present invention may also include such program that does not include the module.

In addition, the program according to the present invention may be incorporated into a part of another program and offered. Also in this case, a program itself does not include a module included in above another program and the process is performed in cooperation with another program. The program according to the present invention may also include such program incorporated into another program.

A program product thus offered is installed in a program storage unit such as a hard disk and is executed. It is noted that the program product includes a program itself and a storage medium having the program stored thereon.

Furthermore, a part or all of the functions (e.g., functional blocks shown in FIGS. 5 and 20) implemented by the program according to the present invention may be configured by dedicated hardware.

It should be understood that the embodiments disclosed herein are illustrative and not limitative in any respect. The scope of the present invention is defined by the terms of the claims, rather than the above description, and is intended to include any modifications within the scope and meaning equivalent to the terms of the claims.

1. An information processing apparatus, comprising:
a display control unit for causing a display unit to display a reference circle at a prescribed position and to display a moving graphic to be movable in accordance with a move command from an operation unit;
a storage unit for storing a plurality of parameters in association with a position on a circumference of said reference circle; and
a range deciding unit for outputting a parameter range corresponding to a portion of the circumference of said reference circle located within said moving graphic, based on a position of said moving graphic.

2. The information processing apparatus according to claim 1, wherein
said moving graphic is a circle.

3. The information processing apparatus according to claim 1, wherein
said parameters are periodic.

4. The information processing apparatus according to claim 1, wherein
said range deciding unit outputs a new parameter range based on said move command, when said moving graphic moves in accordance with said move command.

5. The information processing apparatus according to claim 1, wherein
said storage unit stores reference circle data specifying the position and a size of said reference circle as well as moving graphic data specifying the position and a size of said moving graphic, and
said range deciding unit includes
an intersection calculator for calculating information about at least one intersection of said reference circle and said moving graphic, based on said reference circle data and moving graphic data,
a parameter calculator for calculating the parameter corresponding to each said intersection, based on the information about each said intersection, and
a range generator for outputting the at least one parameter as a boundary value defining said parameter range.

6. The information processing apparatus according to claim 5, wherein
said range deciding unit further includes a determining unit for determining whether or not a center position of said moving graphic is located within a prescribed distance from a center position of said reference circle, and
said range generator outputs a parameter range corresponding to an entire portion of the circumference of said reference circle, when the center position of said moving graphic is located within the prescribed distance from the center position of said reference circle.

7. The information processing apparatus according to claim 1, wherein
when said reference circle is tangent to said moving graphic at one point, said range deciding unit outputs a parameter corresponding to the tangent point.

8. The information processing apparatus according to claim 1, wherein
said operation unit accepts a change command to change a size of said moving graphic, and
said range deciding unit changes the size of said moving graphic based on said change command.

9. The information processing apparatus according to claim 1, wherein
when said moving graphic moves away from said reference circle, said range deciding unit increases a radius of said reference circle such that said reference circle becomes tangent to said moving graphic.

10. The information processing apparatus according to claim 5, wherein
said operation unit accepts a fix command to fix any one of said intersections, and
said range deciding unit moves said moving graphic in accordance with said move command, with any one of said intersections fixed based on said fix command.

11. The information processing apparatus according to claim 5, wherein
said operation unit accepts a fix command to fix any one of said intersections, and
said range deciding unit increases or decreases a size of said moving graphic in accordance with said move command, with any one of said intersections fixed based on said fix command.

12. The information processing apparatus according to claim 1, wherein
said storage unit stores a plurality of files having attributes corresponding to said parameters, and
the information processing apparatus further comprises
an extracting unit for extracting a file having an attribute corresponding to said parameter range from said storage unit and outputting the file, based on said parameter range.

13. The information processing apparatus according to claim 12, wherein
said display control unit causes said display unit to display the file extracted by said extracting unit.

14. The information processing apparatus according to claim 13, wherein
said file is an image file, and
said display control unit causes said display unit to display a thumbnail image based on the image file extracted by said extracting unit.

15. An information processing method in an information processing apparatus including a storage unit and a processing device, comprising the steps of:
storing, by said storage unit, a parameter in association with a position on a circumference of a reference circle;
causing, by said processing device, a display unit to display said reference circle at a prescribed position and to display a moving graphic to be movable in accordance with a move command from an operation unit; and
outputting, by said processing device, a parameter range corresponding to a portion of the circumference of said reference circle located within said moving graphic, based on a position of said moving graphic.

16. A computer-readable recording medium having recorded a program for causing an information processing apparatus including a storage unit and a processing device to output a parameter range,
said program causing the processing device to perform the steps of:
storing a parameter in the storage unit in association with a position on a circumference of a reference circle;
causing a display unit to display said reference circle at a prescribed position and to display a moving graphic to be movable in accordance with a move command from an operation unit; and
outputting the parameter range corresponding to a portion of the circumference of said reference circle located within said moving graphic, based on a position of said moving graphic.
